(19) United States
(12) Patent Application Publication
(10) Pub. No.: US 2021/0355839 A1
(43) Pub. Date: Nov. 18, 2021

(54) COUNTER-ROTATING REVERSING ENERGY STORAGE TURBO MACHINE

(71) Applicants: James Kesseli, Geenland, NH (US); Thomas Wolf, Winchester, MA (US)

(72) Inventors: James Kesseli, Geenland, NH (US); Thomas Wolf, Winchester, MA (US)

(21) Appl. No.: 17/169,234

(22) Filed: Feb. 5, 2021

Related U.S. Application Data
(60) Provisional application No. 62/970,239, filed on Feb. 5, 2020.

(51) Int. Cl. F01D 13/00; F02C 3/04

(52) U.S. Cl. CPC F01D 13/006; F05D 2220/76; F02C 3/04

(57) ABSTRACT

Electrical energy storage is critical to increased adoption of renewable energy resources such as solar and wind power. Apparatuses, systems and methods are disclosed for storing electrical energy as thermal energy and retrieving electrical energy from the stored thermal energy on a large utility scale.

### CROSS REFERENCE TO RELATED APPLICATION

The present application claims the benefits of U.S. Provisional Application Ser. No. 62/970,239 filed Feb. 5, 2020, entitled “Counter-Rotating Reversing Energy Storage Turbomachine”, which is incorporated herein by this reference in its entirety.

### GOVERNMENT LICENSE RIGHTS

This invention was made with government support under grant AR0000998 awarded by the Department of Energy. The government has certain rights in the invention.

### FIELD

The disclosure relates generally to thermal energy storage systems and particularly to a counter-rotating, reversing Brayton-cycle apparatus.

### BACKGROUND

The Brayton-Laughlin Cycle is a method for storing electrical energy as thermal energy on a large utility scale. Electrical energy storage is critical to increased adoption of renewable energy resources such as solar and wind power. The Brayton-Laughlin cycle employs a Brayton-cycle generator and a heat pump to serve as a rechargeable electrical energy storage ‘battery’. The energy is actually stored as sensible heat energy in thermal reservoirs, also referred to as a heat source. In simple terms, the Brayton cycle, also known as a gas turbine cycle, converts high temperature stored thermal energy to generate shaft power. A generator or alternator converts the turbine shaft power into electricity. While this high temperature reservoir may be recharged with electrical resistance heaters, for example, it is more efficient to employ a ‘heat pump’. Therefore to charge the cycle and store energy, a motor-driven heat pump is employed to replenish the thermal reservoir, or heat source. When employing a Brayton cycle heat pump, the thermodynamic Brayton-Laughlin cycle is reversible, absorbing electric motor power to pump heat energy from ambient conditions into the high temperature heat source reservoir, and returning its temperature which drives the power generation gas turbine cycle. There remains a need for apparatuses, systems and methods for storing electrical energy as thermal energy and retrieving electrical energy from the stored thermal energy on a large utility scale.

### SUMMARY

The present disclosure was created in response to demands to lower the cost of the overall Laughlin-Brayton energy storage system. As described by Laughlin, the electrical energy storage system utilizes two turbo machines: a gas turbine generator and a motor-driven heat pump. The gas turbine generator comprises a compressor, a turbine, and a generator. The Brayton cycle heat pump comprises a motor, a turbine and a compressor.

The present disclosure describes a novel single turbo machine which combines the two functions of the distinct apparatuses into a single apparatus, thereby lowering cost and improving efficiency. This disclosure describes an apparatus that comprises a turbine, a compressor and an electrical motor/generator. A motor and a generator are physically similar and only the current flow direction and application or use distinguish a motor from a generator. When provided with an electrical voltage potential, the electrical machine may serve as a motor to drive a load. When the shaft of the electrical machine is driven by an engine, it serves as a generator. The voltage potential may reverse, as will the direction of the current and power. The disclosure also describes the general principles of a turbine and compressor; aerodynamic components employed to expand and compress gas. As the pressurized gas flows through the rotor blades, the turbine or expander operates between a high pressure and low pressure gas stream, extracting energy through a shaft. A compressor absorbs shaft power to accelerate gas from a low pressure source, delivering it to a higher pressure.

This disclosure also describes a turbo machinery apparatus that comprises a first turbine, a first compressor, and dual functioning motor/generator which are mechanically connected to one another. This apparatus is designed to function in two operational modes: first as a power generator, and second as a heat pump. In power generation mode, gas enters said first compressor section, is compressed, receives heat from the high temperature reservoir, then flows through said first turbine which produces sufficient power to drive the first compressor and the motor/generator (as a generator). In heat pump mode, the gas direction reverses through the apparatus. The first turbine, with flow direction reversed, acts as a compressor, while the first compressor, with flow direction reversed, operates as a turbine.

This disclosure also describes specific and detailed aerodynamic principles for enabling the first compressor to operate as a turbine and the first turbine to operate as a compressor when called upon to function in the two different modes. Both compressor and turbine are described as multi-stage bladed rotor assemblies. The turbine and compressor have an odd number of individual blade rows (or bladed disks). Each of the blade rows or bladed disks is mechanically connected such that the turbine and compressor blade rows rotate in alternating clockwise and counterclockwise directions. For clarity, the air flowing in either direction, depending on the operating mode, encounters alternating clockwise and counterclockwise blade rows. Further, when toggling between power generation and heat pump modes, the direction of rotation of each blade row changes. For clarity, if a given blade row is rotating in the clockwise direction in power generation mode, it will rotate in a counterclockwise direction in the heat pumping mode.

The disclosure also describes a mechanical system for the turbo machinery apparatus that comprises an internal rotating shaft forming the axis of the bladed rotors, combined with an outer rotating ‘drum’, carrying alternating bladed rotors, configured to rotate about a common axis.

One particular embodiment of the present disclosure is an apparatus for transferring energy in an energy storage system, comprising a cold turbo machine having a plurality of blade rows, wherein an outer diameter of each blade row of the plurality of blade rows of the cold turbo machine descends in size between a first opening and a second opening of the cold turbo machine; a hot turbo machine having a plurality of blade rows, wherein an outer diameter of each blade row of the plurality of blade rows of the hot turbo machine descends in size between a first opening and a second opening of the hot turbo machine, and wherein a common shaft operably joins the plurality of blade rows of the cold turbo machine and the plurality of blade rows of the hot turbo machine; and a motor/generator operably engaged to the common shaft, wherein, in a first mode of operation, electricity is supplied to the motor/generator which drives the common shaft such that the cold turbo machine is a turbine and the hot turbo machine is a compressor, and wherein, in a second mode of operation, the cold turbo machine is a compressor and the hot turbo machine is a turbine to rotate the common shaft such that the motor/generator produces electricity.

In some embodiments, the plurality of blade rows of the cold turbo machine have an odd number of blade rows, and the odd-numbered blade rows rotate in a first direction and the even-numbered blade rows rotate in an opposing, second direction during the first mode of operation, and the odd-numbered blade rows rotate in the second direction and the even-numbered blade rows rotate in the first direction during the second mode of operation; and wherein the plurality of blade rows of the hot turbo machine have an odd number of blade rows, and the odd-numbered blade rows rotate in the first direction and the even-numbered blade rows rotate in the second direction during the first mode of operation, and the odd-numbered blade rows rotate in the second direction and the even-numbered blade rows rotate in the first direction during the second mode of operation.

In various embodiments, the common shaft comprises an inner shaft connected to the odd-numbered blade rows of the plurality of blade rows of the cold turbo machine and connected to the odd-numbered blade rows of the plurality of blade rows of the hot turbo machine, and the common shaft comprises an outer shaft connected to the even-numbered blade rows of the plurality of blade rows of the cold turbo machine and connected to the even-numbered blade rows of the plurality of blade rows of the hot turbo machine.

In some embodiments, the motor/generator is connected to the inner shaft, and a second motor/generator is connected to the outer shaft. In various embodiments, the motor/generator is connected to one end of the common shaft, and the second motor/generator is connected to an opposing end of the common shaft. In some embodiments, the apparatus further comprises at least one magnetic bearing between the inner shaft and the outer shaft such that the inner shaft and the outer shaft do not contact each other. In various embodiments, a first magnetic bearing is positioned proximate to a non-magnetic portion of the outer shaft and a magnetic portion of the inner shaft, and a second magnetic bearing is positioned proximate to a magnetic portion of the outer shaft.

Another particular embodiment of the present disclosure is an apparatus for transferring energy in an energy storage system, comprising a cold turbo machine having a plurality of blade rows, wherein a blade of at least one blade row of the plurality of blade rows of the cold turbo machine has a leading edge geometry that is substantially the same as a trailing edge geometry; a hot turbo machine having a plurality of blade rows, wherein a blade of at least one blade row of the plurality of blade rows of the hot turbo machine has a leading edge geometry that is substantially the same as a trailing edge geometry, and wherein a common shaft operably joins the plurality of blade rows of the cold turbo machine and the plurality of blade rows of the hot turbo machine; and a motor/generator operably engaged to the common shaft, wherein, in a first mode, electricity is supplied to the motor/generator which drives the common shaft such that the cold turbo machine operates as a turbine and the hot turbo machine operates as a compressor, and wherein, in a second mode, the cold turbo machine operates as a compressor and the hot turbo machine operates as a turbine to rotate the common shaft such that the motor/generator produces electricity.

In some embodiments, velocity triangles characterizing a flow of working fluid at the leading edge and at the trailing edge of the blade of at least one blade row of the plurality of blade rows of the cold turbo machine are substantially symmetric between the first mode and the second mode; and wherein velocity triangles characterizing a flow of working fluid at the leading edge and at the trailing edge of the blade of at least one blade row of the plurality of blade rows of the hot turbo machine are substantially symmetric between the first mode and the second mode. In various embodiments, an outer diameter of each blade row of the plurality of blade rows of the cold turbo machine descends in size between a first opening and a second opening of the cold turbo machine, and wherein an outer diameter of each blade row of the plurality of blade rows of the hot turbo machine descends in size between a first opening and a second opening of the hot turbo machine.

In some embodiments, a cross-sectional area of the first opening of the hot turbo machine is greater than a cross-sectional area of the second opening of the hot turbo machine, greater than a cross-sectional area of the first opening of the cold turbo machine, and greater than a cross-sectional area of the second opening of the cold turbo machine. In various embodiments, the outer diameter of each blade of the plurality of blades of the hot turbo machine is greater than the outer diameter of each blade of the plurality of blades of the cold turbo machine. In some embodiments, the apparatus further comprises a first non-rotating blade row at one end of the plurality of blade rows of the cold turbo machine and a second non-rotating blade row at an opposing end of the plurality of blade rows of the cold turbo machine. In various embodiments, the common shaft is configured to rotate between 3300 and 3900 revolutions per minute in the first mode and between approximately 3300 and 3900 revolutions per minute in the second mode.

A further particular embodiment of the present disclosure is an energy transfer system, comprising a turbine and a compressor arranged on a common shaft, wherein a motor/generator is operably connected to the common shaft; a hot reservoir having a higher temperature than a cold reservoir; wherein, in a first mode of operation, a working fluid flows from the cold reservoir to an inlet of the compressor where the working fluid is compressed and exits through an outlet of the compressor at a higher temperature; wherein the working fluid flows from the compressor to the hot reservoir where the working fluid further increases in temperature; wherein the working fluid flows from the hot reservoir to an inlet of the turbine where the working fluid causes the turbine to rotate the common shaft, which causes the motor/generator to produce electricity; wherein the working fluid exits through an outlet of the turbine at a lower temperature and returns to the cold reservoir; and wherein, in a second mode of operation, electricity is supplied to the motor/generator to rotate the common shaft, the working fluid flows in the opposite direction, the turbine functions as a second compressor, and the compressor functions as a second turbine to transfer heat energy from the cold reservoir to the hot reservoir.

In some embodiments, the system further comprises a heat exchanger where the working fluid flowing out of the outlet of the turbine transfers heat to the working fluid flowing from the outlet of the compressor to the hot reservoir. In various embodiments, the compressor has a plurality of blade rows, wherein an outer diameter of each blade row of the plurality of blade rows of the compressor descends in size between the inlet and the outlet of the compressor along a first longitudinal direction along the common shaft; and wherein the turbine has a plurality of blade rows, wherein an outer diameter of each blade row of the plurality of blade rows of the turbine descends in size between the outlet and the inlet of the turbine in an opposing, second longitudinal direction along the common shaft.

In some embodiments, the plurality of blade rows of the compressor have an odd number of blade rows, and the odd-numbered blade rows rotate in a first rotational direction and the even-numbered blade rows rotate in an opposing, second rotational direction during the first mode of operation, and the odd-numbered blade rows rotate in the second rotational direction and the even-numbered blade rows rotate in the first rotational direction during the second mode of operation; and wherein the plurality of blade rows of the turbine have an odd number of blade rows, and the odd-numbered blade rows rotate in the first rotational direction and the even-numbered blade rows rotate in the second rotational direction during the first mode of operation, and the odd-numbered blade rows rotate in the second rotational direction and the even-numbered blade rows rotate in the first rotational direction during the second mode of operation.

In various embodiments, the common shaft comprises an inner shaft connected to the odd-numbered blade rows of the plurality of blade rows of the compressor and connected to the odd-numbered blade rows of the plurality of blade rows of the turbine, and the common shaft comprises an outer shaft connected to the even-numbered blade rows of the plurality of blade rows of the compressor and connected to the even-numbered blade rows of the plurality of blade rows of the turbine. In some embodiments, the motor/generator is connected to the inner shaft, and a second motor/generator is connected to the outer shaft, and wherein the motor/generator is connected to one end of the common shaft, and the second motor/generator is connected to an opposing, second end of the common shaft.

The following definitions are used herein:

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

An energy storage system refers to any apparatus that acquires, stores and distributes mechanical, thermal or electrical energy which is produced from another energy source such as a prime energy source, a regenerative braking system, an overhead wire and any external source of electrical energy. Examples are a battery pack, a bank of capacitors, a compressed air storage system and a flywheel.

An engine refers to any device that uses energy to develop mechanical power, such as motion in some other machine. Examples are diesel engines, gas turbine engines, microturbines, Stirling engines and spark ignition engines.

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

A prime power source refers to any device that uses energy to develop mechanical or electrical power, such as motion in some other machine. Examples are diesel engines, gas turbine engines, microturbines, Stirling engines, spark ignition engines or fuel cells.

The phrases at least one, one or more, and and/or are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the disclosure. In the drawings, like reference numerals may refer to like or analogous components throughout the several views.

FIG. 1 illustrates state of the art turbo machines.

FIG. 2 is a simplified schematic of the turbo machinery apparatus.

FIG. 3 illustrates velocity vectors for a state of the art axial flow turbo machine.

FIG. 4 illustrates the aerodynamic vector diagram of the counter-rotating blade rows of the present disclosure.

FIG. 5 illustrates a conventional velocity diagram for describing the flow angles and velocity magnitudes in the present disclosure.

FIGS. 6a, 6b, and 6c illustrate the nomenclature of the present disclosure.

FIG. 7 illustrates the principles of the present disclosure.

FIG. 8 is a detailed solid model showing the mechanical arrangement of one practical embodiment of the present disclosure.

FIG. 9 illustrates the detailed solid model showing the details of the coaxial bearings.

FIG. 10 illustrates the schematic details of one embodiment of a pass-through magnetic bearing.

FIG. 11 is a schematic diagram showing the temperatures and pressures and flow conditions.

FIG. 12 illustrates the gas flow velocity vectors relative to the blade metal angle for operation in compressor and turbine modes, with numerical results tabulated.

FIG. 13 is a cross-sectional drawing of the cold compressor/turbine, with details of the counter-rotating blade rows, and co-axial shaft and bearings.

### DETAILED DESCRIPTION OF THE DRAWINGS

This disclosure relates to a turbo machine that comprises mechanically connected compressor, turbine, and electrical machine for converting shaft power to electric power. This single mechanical system is designed to operate in two distinct modes; heat pump and gas turbine engine. A mechanically connected first turbine, a first compressor, and first electrical machine form a motor driven heat pump. A mechanically connected second compressor, second turbine, and second electrical machine functioning as a gas turbine generator. When toggling between modes or functions, said first compressor machine functions as the said second turbine and said first turbine functions as said second compressor and said first electrical machine functions as a generator.

### PRIOR ART

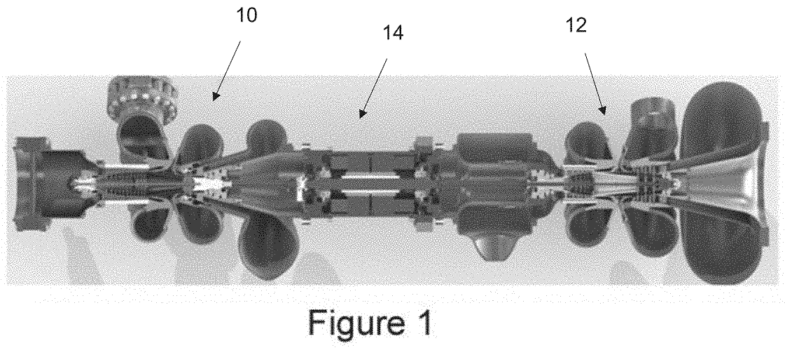

The Laughlin-Brayton battery operates with a motor-driven heat-pump, for electrical charging and gas turbine generator for electrical discharge (power generation). FIG. 1 illustrates an example of two functioning turbo machines 10, 12 mechanically connected to a single electrical machine 14, for conversion of shaft power to electrical power. The so-called electrical machine 14 is commonly referred to as a motor when converting electrical power to shaft power and as a generator or alternator, when converting shaft power to electrical power. The motor/generator 14 serves as a motor during charging, or heat pump mode, and as a generator during generation mode.

FIG. 1 illustrates state of the art heat pump turbo machine 10 connected to separate gas turbine generator 12. Both share a common electrical machine 14; a first turbo machine 12, is designed as a gas turbine generator and a second turbo machine is designed as a heat pump 10. While separate motor and generator may be employed to totally decouple these turbo machines, this embodiment uses a dual-purpose motor/generator 14 located centrally. To function, a clutch would be used to enable the two machines to operate independently and at different times. For example the heat pump turbo machine 10, on the left, operates during electrical absorption periods, drawing electricity from a source (utility grid or non-dispatchable renewable power source) employing the electrical machine 14 as a motor. In this case the right-hand turbo machine 12 is decoupled by a clutch, for example, so that it is not driven by said motor 14. In periods of electrical demand, the heat pump 10 is turned off, de-clutched, and the gas turbine engine turbo machine 12 (right side) is re-clutched. In this mode the electrical machine 14 serves as a generator, driven by the turbine 12. An important feature of conventional state of the art turbo machines, either turbine or a compressor, is that a static, non-rotating stator vanes are located in front of each rotating blade row. This stator vane serves to turn the gas flow to the optimal angle of incidence for the rotating blade row. In subsequent discussions, it will be shown that said static stator rows may be eliminated in this disclosure, thereby reducing loss-generating friction and aerodynamic wakes.

### THE PRESENT DISCLOSURE

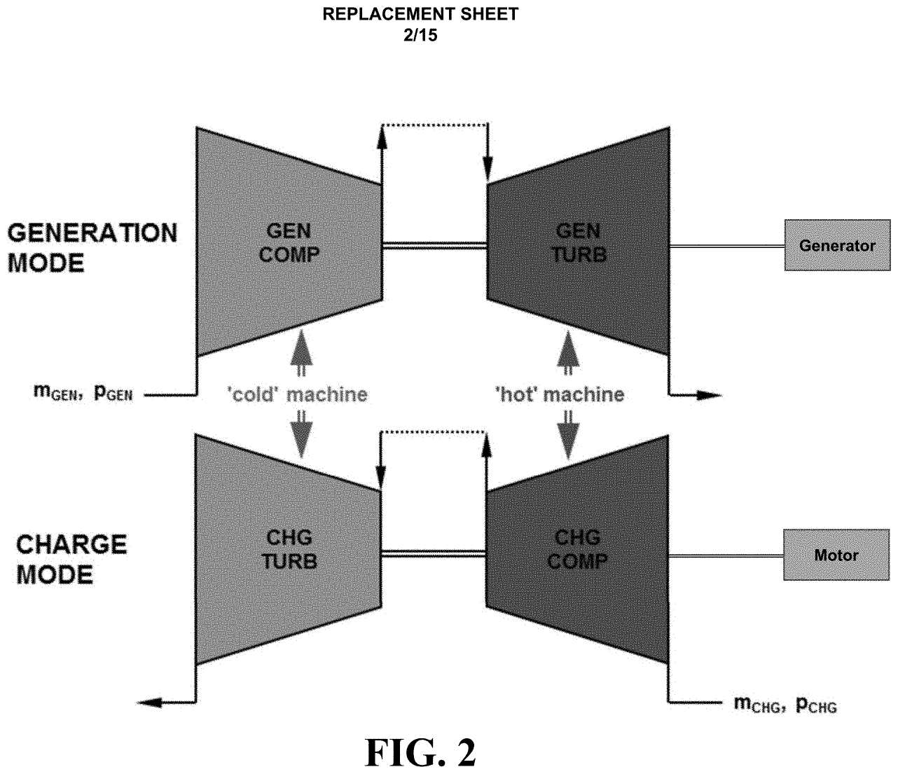

FIG. 2 is a simplified schematic of the turbo machinery apparatus that comprises a compressor section, a turbine section, and an electrical machine which converts shaft power to electrical power. These three major sections are connected by a common shaft. In the upper figure, the gas enters the cool compressor, passes through the hot turbine and delivers electrical power through the generator. In the lower schematic, the flow direction is reversed, wherein the gas enters on the right side hot compressor, and flows to a cool turbine, with the turbo machine shaft powered by a motor. The annotation indicates the symmetry between the cold compressor and the cold turbine, and likewise, the symmetry between the hot turbine and the hot compressor.

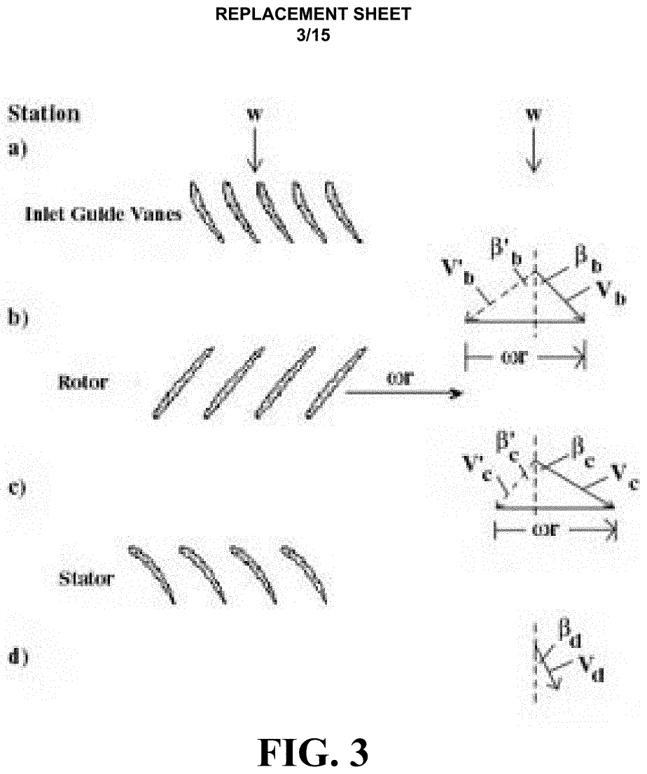

FIG. 3 illustrates velocity vectors for an axial flow turbo machine, showing the gas flowing through alternating stator (a static blade row) and rotor (rotating blade) rows. Conventional representation of velocity vectors through a multi-stage compressor or turbine. Rotors are the rotating bladed rows. Stators are the stationary blade rows. This is a 2-dimensional representation of a cut through the annular volume in a turbine or compressor. The stators are designed to turn the flow to the optimal incidence angle to allow the rotors to maximize work extraction and efficiency. In typical gas turbines and large industrial axial flow compressors, many (e.g. 5 to 20) blade-stator pairs are required to achieve the high pressure ratios or expansion ratios in modern aviation propulsion or power generation equipment.

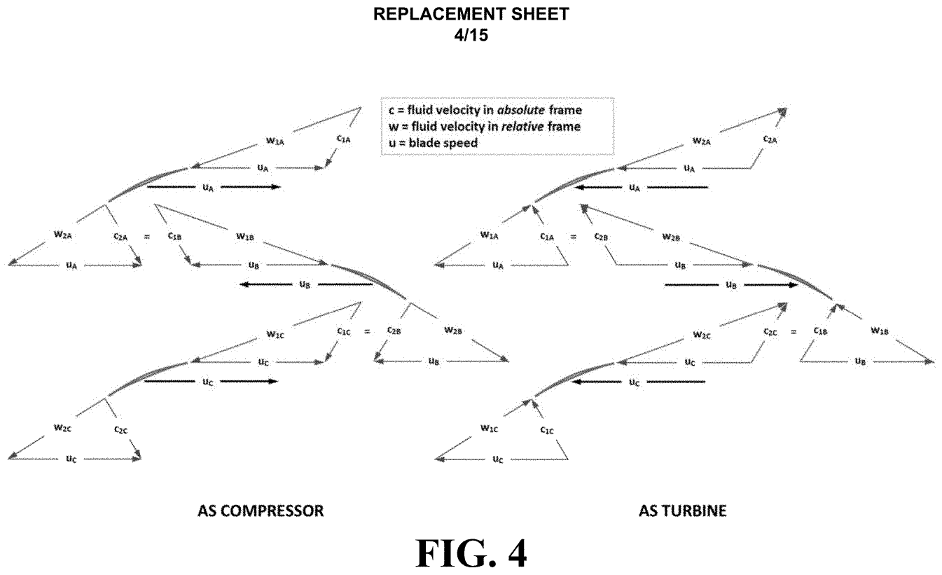

FIG. 4 illustrates the aerodynamic vector diagram of the counter-rotating blade rows of the disclosure. The velocity vectors illustrate the symmetry in the alternating rows rotating in opposite directions. A stationary blade row initiates the flow angle entering the first blade row, and these blade rows are designed by means of aerodynamic, thermodynamic, and structural design rules to operate in unison. Also described in the vector diagram is the symmetry to the flow in reverse direction. By precise manipulation of the compressor and turbine geometry, symmetrical flow fields have been achieved when operating in both directions. Aerodynamicists would also note the distinction between the state of the art air foil, as depicted in FIG. 3 and those selected for the disclosure in FIG. 4. Typically the leading edge of an air foil, including those used in turbine and compressor blade design, employs a rounded leading edge to enable the flow to board the blade without stalling or the creating wakes. Stall and wake formations reduce the work and efficiency of a blade. Conversely, typical air foils incorporate a sharp trailing edge, where the gas leaves the blade surface. This is for similar reasons, to prevent flow separation and wakes which cause drag and efficiency loss. In the present disclosure, an air foil is devised with relatively sharp edges on both leading and trailing edges. This introduces design constraints on the designs operating range and narrows the designers range to achieve high efficiency in both compressor and turbine operating modes.

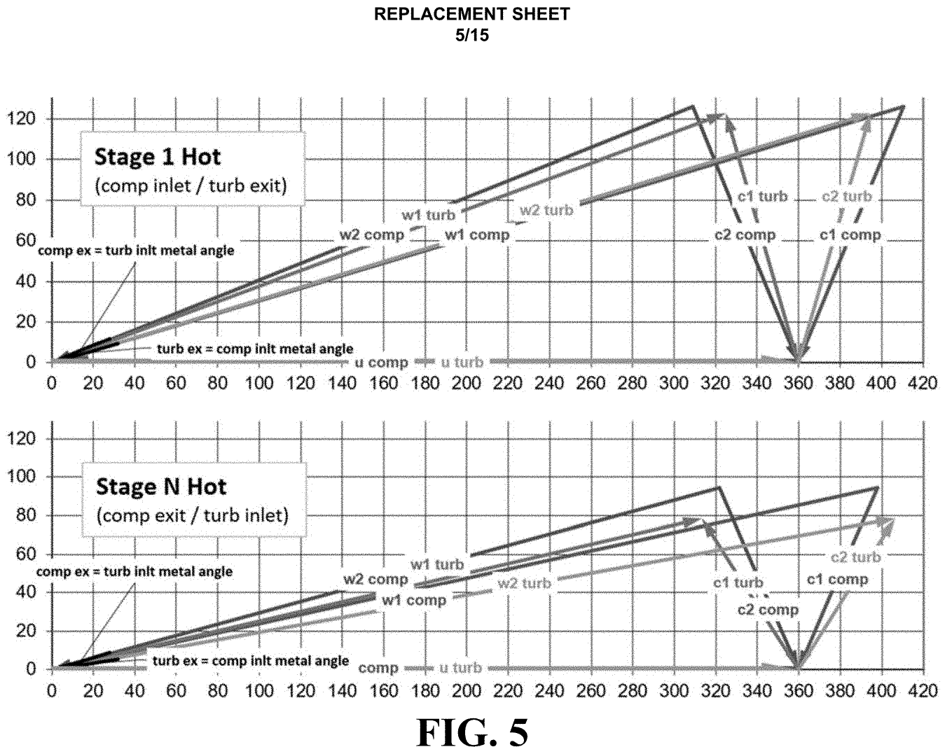

FIG. 5 illustrates a conventional velocity diagram for describing the flow angles and velocity magnitudes in the present disclosure. This specific diagram illustrates the velocity diagrams for the hot heat pump compressor employed in charge mode, which also serves as the hot turbine in generation mode. This figure shows the symmetry exploited to achieve efficient operation in both flow directions, as a compressor and a turbine. This turbo machine comprises a stator, a stationary blade row, or nozzle, and a series of repeating stages. The inventors strive to manipulate the geometric parameters to achieve symmetry in the operation in both flow directions and for the two distinct operating modes: compression and expansion. In some embodiments, the blade has a leading edge with a geometry that is substantially the same as a geometry of a trailing edge of the blade. The terms “substantially” and “approximately” can imply a variation of +/−10% on a relative basis.

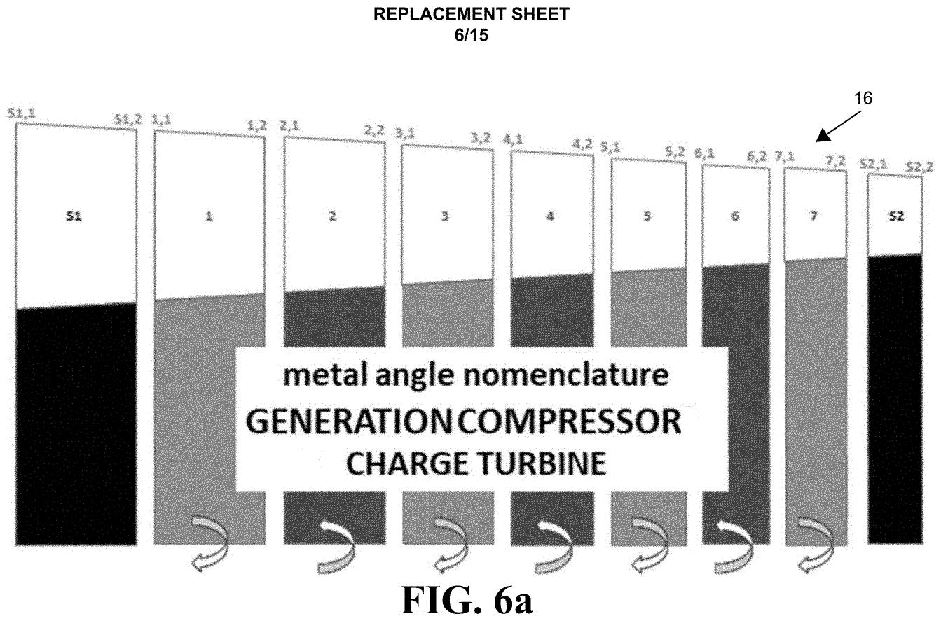

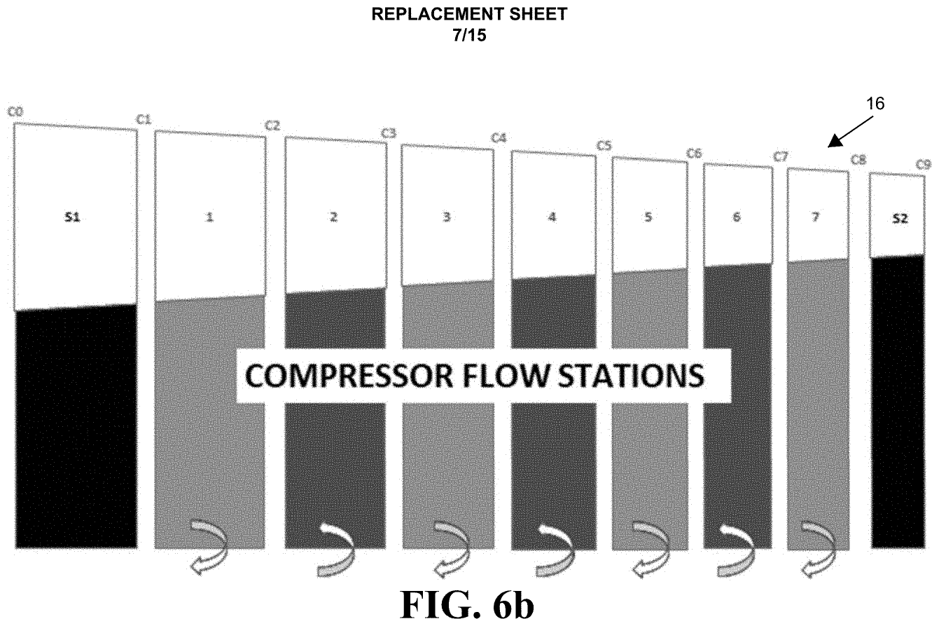

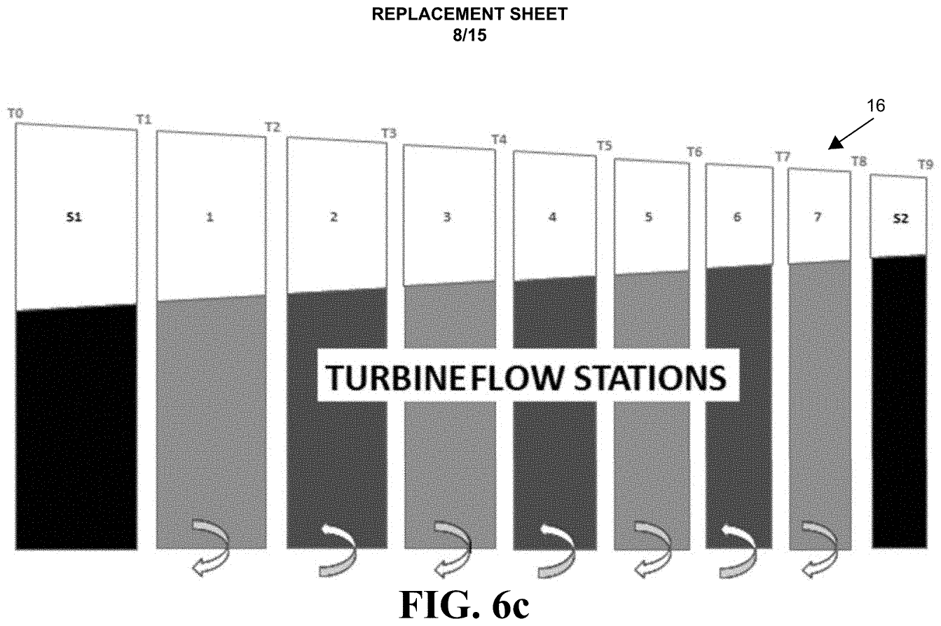

FIGS. 6a, 6b, 6c illustrate the nomenclature of the disclosure in simplified terms. Each turbo machine comprises a static stator vane S1, S2 at the front and exit planes of the rotating blade rows 1-7. The alternating blade rows 1-7 rotate in opposite, clockwise and counterclockwise, directions flanked by stators S1, S2 at the entrance and exit. In some embodiments, the cold turbo machinery is configured as generation compressor and charge turbine 50 MW/3,600 rpm—7 rotating stages. In some embodiments, the shaft rotates between approximately 3,300 and 3,900 rpms in either direction in either mode of operation. The choice of stage count is governed by choice of compressor-stage specific speed and by Mᵣₑₗ considerations (highest at compressor inlet and turbine exit).

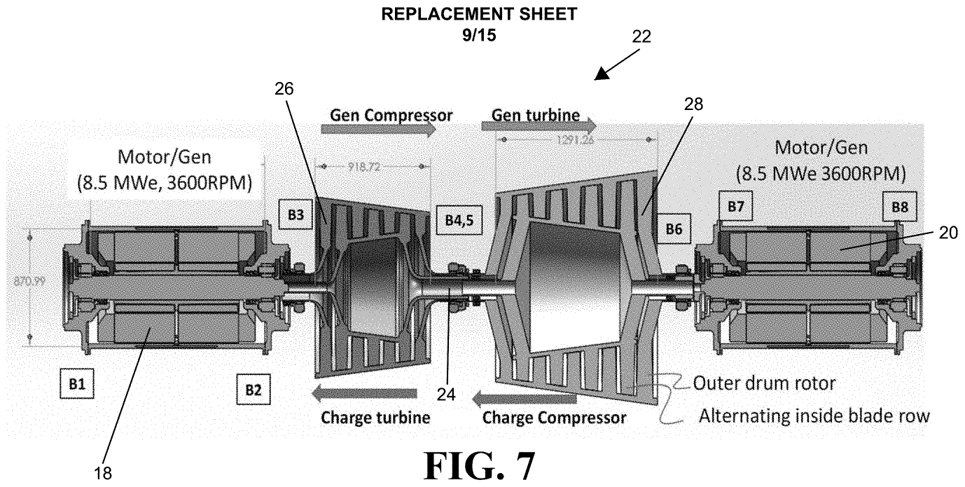

FIG. 7 illustrates the principles of the disclosure that comprises two motor/generators 18, 20 arranged on opposite ends of the turbo machine 22. The first motor/generator 18 operates in the clockwise direction of rotation, while the second motor/generator 20 operates in the counterclockwise direction. The turbo machine 22 operates with a co-axial shaft 24, both rotating about a common axis. The turbo machine comprises a first, left-hand set of blade rows of a cold turbo machine 26 and a second, right-hand set of blade rows of a hot turbo machine 28. The rendering shows that the first, left-hand motor/generator is mechanically connected to the outer drum rotor via an outer shaft and the second left-hand motor/generator is mechanically connected to the inner rotor group via an inner shaft. Both first and second sets of blade rows comprise alternating clockwise and counterclockwise blade rows.

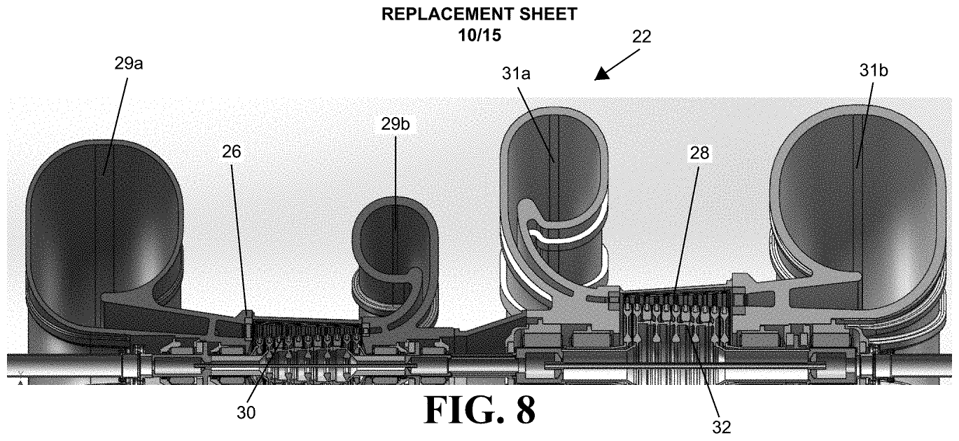

FIG. 8 is a detailed solid model showing the mechanical arrangement of one practical embodiment of the disclosure. The device 22 comprises a ‘cold’ set of blade alternating rows 30 on the left side and ‘hot’ set of blade alternating rows 32 on the right side. The cold blade rows 30 functions as a turbine during heat pump or electrical charging. The same blade rows 30 function as the cold compressor in the generation power cycle when flow and direction of rotations are reversed. Similarly, the hot end operates in both compressor and turbine modes, with reversing flow and rotation. The term “turbo machine” can refer to the entire device or apparatus and/or individual devices that operate as a compressor and/or turbine. In addition, the cold turbo machine 30 has openings 29a, 29b at either end that serve as inlets and outlets of the cold turbo machine 30. Further, the hot turbo machine 32 has openings 31a, 31b at either end that serve as inlets and outlets of the hot turbo machine 32. Due to the difference in expected temperatures between the machines 30, 32 among other factors, the opening 31b proximate to the largest blade row is larger in terms of cross-sectional area and volume than the other openings 29a, 29b, 31a.

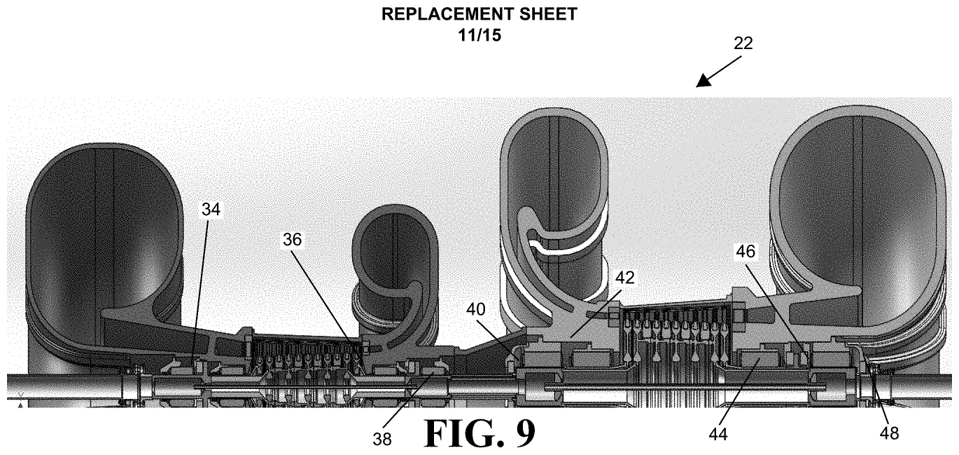

FIG. 9 illustrates the detailed solid model showing the details of the coaxial bearings. This embodiment illustrates magnetic bearings, including radial bearings on each end and a novel coaxial pass through bearing. Specifically FIG. 9 shows an inner rotor standard bearing 34, an outer rotor bearing 36, inner rotor pass-through bearing 38, inner rotor pass-through bearing 40, outer rotor bearing 42, outer rotor bearing 44, inner rotor pass-through bearing 46, and inner rotor standard bearing 48. Rolling element, or ball bearings may also be employed to create two coaxial inner and outer shaft rotor system. A preferred arrangement is shown employing magnetic bearings for the avoidance of lubricants and seals.

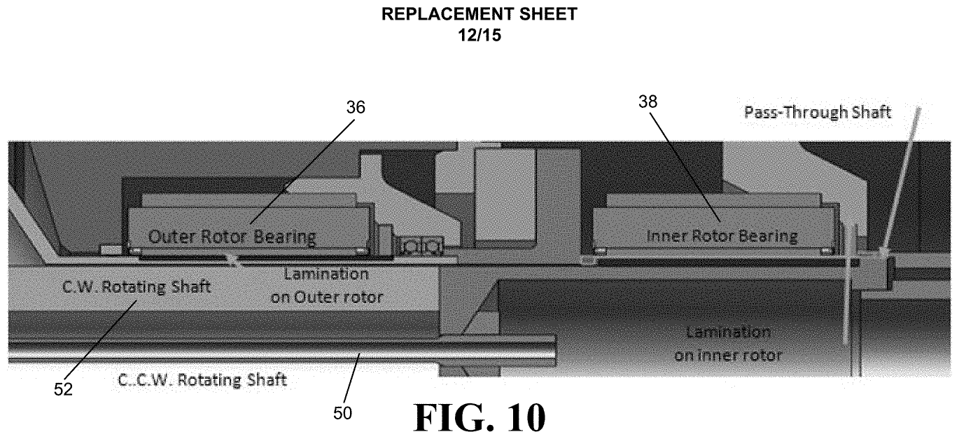

FIG. 10 illustrates the schematic details of one embodiment of a pass-through magnetic bearing. A magnetic bearing is a static element which supports the magnetized shaft by levitation, employing electro-magnets. The arrangement employs two radial bearings, a first bearing 40 supports the inner rotating shaft 50 while the second magnetic bearing 42 supports the outer sleeve 52 of the coaxial shaft. The outer rotating sleeve 52 comprises two segments; a first non-magnetic segment and a second magnetic segment. The inner solid shaft 50 rotating about the axis of the turbo machine is magnetic. The first non-magnetic segment is radially inboard of the first magnetic bearing 40 such that magnetic levitation acts only on the inner ferrous or magnetic shaft 50, and does not affect the position of the outer magnetic sleeve 52, rotating in the opposite direction. The second radial bearing 42 is radially outboard of the second rotating shaft sleeve of the annular coaxial shaft 52, and owing to its magnetic or ferrous alloy, levitates only the outer sleeve 52, with no influence on the inner rotating shaft 50. In the illustration the outer rotating sleeve 52 is mechanically connected to the outer drum which carries alternating or odd numbered blade rows in a first direction or rotation, and the inner solid shaft 50 carries the alternating even numbered blade rows in the opposite direction or rotation.

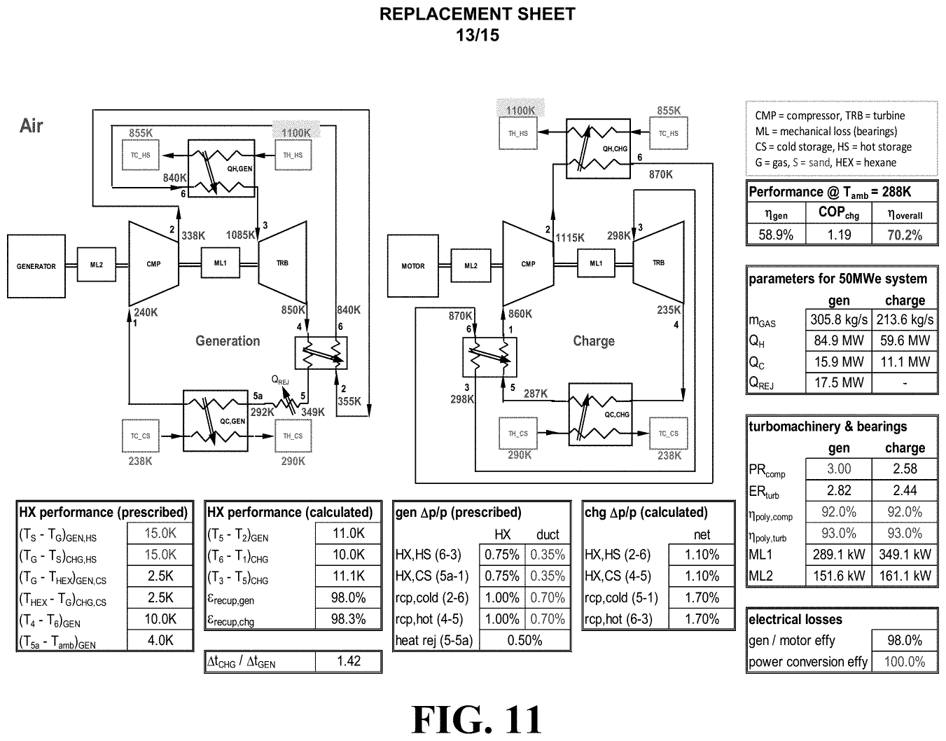

FIG. 11 a schematic diagram showing the temperatures and pressures and flow conditions for separate gas turbine generator and heat pump electrical charging turbo machines. The system 54 comprises a cold turbo machine 56, a hot turbo machine 58, hot thermal storage 60, cold thermal storage 62 and several heat exchangers 64 to enable the transfer of energy from the turbo machinery working fluid to the sensible thermal storage system. The balance of plant, as taught by Laughlin includes heat exchangers for exchanging heat between the turbo machinery working gas and the hot and cold thermal storage media. This specific configuration employs air as the turbo machinery working fluid, however one skilled in the art will recognize that the subject disclosure may also use other gasses.

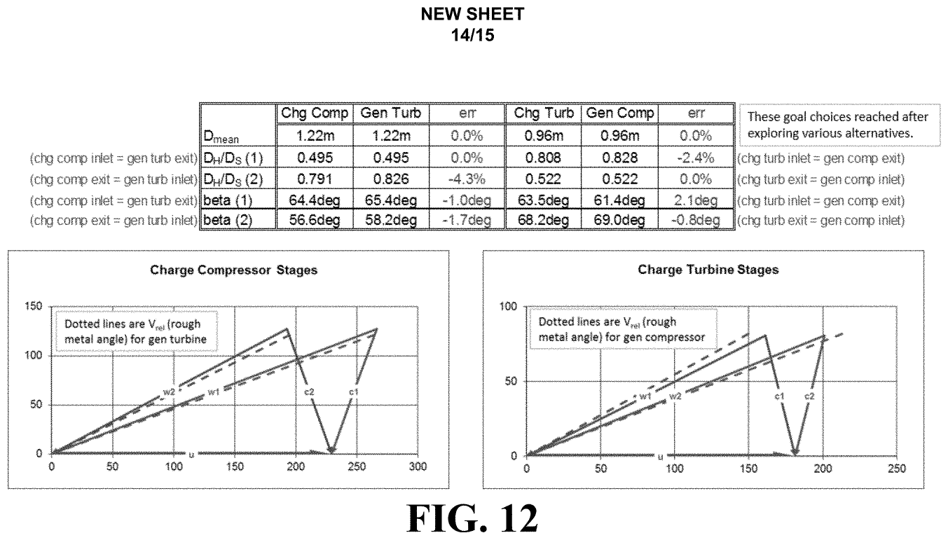

FIG. 12 illustrates the gas flow velocity vectors relative to the blade metal angle for operation in compressor and turbine modes, with numerical results tabulated. The associated table lists the errors or deviations from the optimal targets when imposing the two flow directions (compressor and turbine) on the common turbo machinery. Detailed mathematical optimization modeling is required to drive the flow deviation errors to minimum, making compromises to achieve the pressure ratio, expansion ratio, and power for overall best efficiency. The tabulated results for one of many cases are listed for example. This mathematical treatment is used to build detailed solid models of the blade shapes for eventual 3-D analysis employing computational fluid dynamic (CFD) methods.

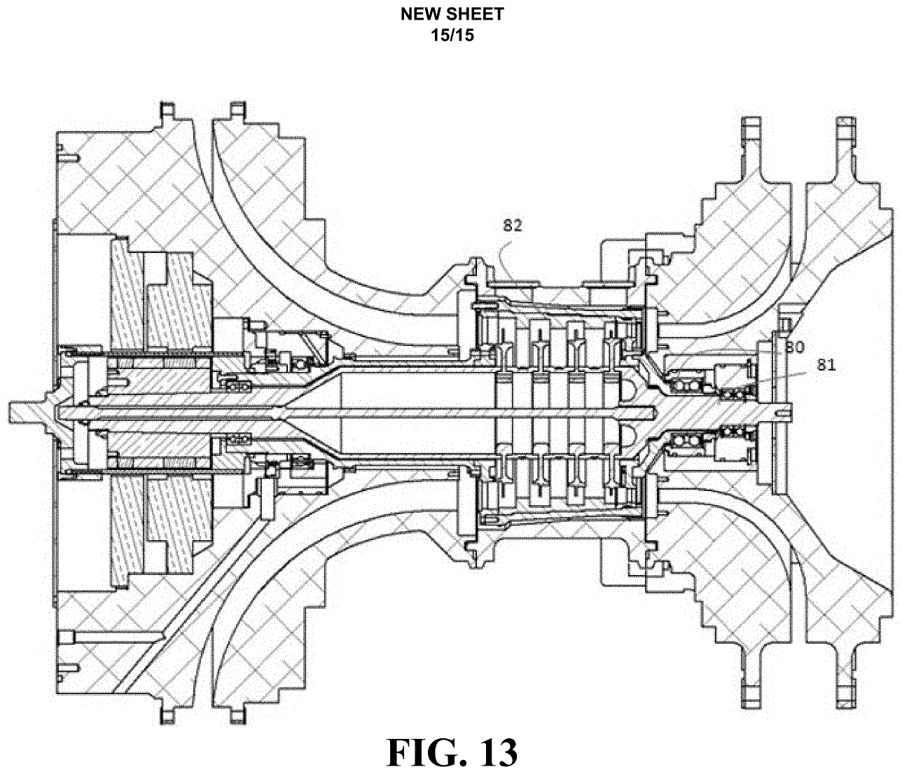

FIG. 13 is a cross-sectional drawing of the cold compressor/turbine, with details of the counter-rotating blade rows, co-axial shaft, a drum 82, and bearings 80, 81. This example incorporates a combination of the aforementioned pass-through coaxial magnetic bearing and conventional rolling element (ball) bearings for performance testing.

### Overview of Aerodynamic and Cycle Innovations

A single turbo machine with reversing flow direction greatly simplifies the interconnecting piping, lowers losses and reduces the overall system cost. A traditional Laughlin-Brayton cycle, heat pump compressor could not function aerodynamically as the compressor in the gas turbine power generation cycle. Likewise, the aerodynamic properties of the heat pump turbine are grossly incompatible with the turbine for the gas turbine cycle. Configuring the single turbo machine to operate backwards, with reversing flow and direction of rotation introduces other challenges, overcome by the present disclosure.

The benefits of counter-rotating aerodynamics have been successfully demonstrated in certain applications such as 2-stage fans and between high and low pressure gas turbine spools, but otherwise the technology is under-researched. This technology not commonly employed in industry for the following reasons;
Pressure ratio: Gas turbine engines strive for much higher pressure ratios than are required for the Laughlin cycle. Counter-rotating machine's complexity grows exponentially with pressure ratio.
Weight and size constraints: Flight systems have extreme weight constraints, pushing for highly loaded stages. Counter-rotating machines require large, lightly loaded blade rows.
Turbine inlet temperatures: Typical cast blades with internal cooling are not geometrically appropriate for a counter-rotating machine.

The aerodynamics of the counter-rotating turbo machine are ideally suited for the Laughlin-Brayton turbo machine. Its low pressure ratio and insensitivity to diameter and weight and desire for low RPM create a strong case for the reversible, counter-rotating turbo machine. The targeted research addresses both efficiency and cost defects of the Laughlin-Brayton Cycle.

### Preliminary Aerodynamic Design Study for Reversible Counter-Rotating Turbomachinery

To assess feasibility of the proposed concept, preliminary aerodynamic design was carried out under representative system specifications of typical 3,600 rpm rotational speed, system pressure equal to 1 atmosphere at the compressor inlet, and air as a working fluid. Thermodynamic requirements for the turbo machinery components, compressor and turbine, in the form of inlet conditions and pressure ratio for each under generation and charge operation, were extracted from Brayton Energy's system performance model whose outputs are tabulated in FIG. 11.

Recognizing that the stage ‘specific speed’ parameter must fall within a prescribed range for high-efficiency axial turbo machinery, rough bounds on system power capacity are established by the choices above and the incentive to hold stage count within acceptable limits. The broad objective of the design exercise was to establish whether turbo machinery blading may be designed for efficient operation in both generation and charge modes, with the directions of flow and rotation reversed between them. At the preliminary design level of this exercise, success criteria are as follows:
The customary stage performance parameters fall in ranges allowing for efficient operation. For axial turbo machinery, these are the stage loading and flow coefficients (Ref 1), respectively (following conventional notation) h/u2 and cx/u, where h is specific enthalpy drop, “u” is blade speed, and “vx” is fluid axial velocity.
Blade-inlet incidence errors remain small in transitioning between generation and charge modes. This promotes favorable aerodynamic performance, and allows for the design of blade sections having narrow leading edges, minimizing trailing-edge blockage under reversed flow.

The aerodynamic design exercise was carried out under simplifications as follows:
Repeating stages
Constant mean-passage radius
Constant axial velocity
Equal work per stage
Simplified loss modeling

Choices for system power capacity in generation mode and spool stage counts are reached in iterative fashion, under the requirement that specific speeds for all turbo machinery stages fall within an acceptable range for efficient operation. Priority in the assignment of stage count was given to compressor performance, recognizing that turbine stage counts will exceed preferred values, with stage specific speed correspondingly high. The achievement of high turbine stage efficiency in this regime is supported by detailed design and CFD analysis performed in connection with a similar application (not described here).

Stated broadly, the aerodynamic design approach was to define (following accepted aerodynamic practice) turbo machinery geometry for operation in generation mode, and then under the numerical procedure described below to drive charge turbo machinery geometry into correspondence with its generation counterpart. This process was carried as follows:
Power level is prescribed for operation in generation mode, and stage counts assigned following the rationale above.
Stage loading and flow coefficients (φ,ϕ Table 1) are chosen for compressor and turbine stages in generation mode. It is noted that with these assignments, and under the specifications and simplifications above, the repeating stage velocity triangles and blade-passage geometry are fully defined.
The turbo machinery design process for charge mode follows that described above, in that stage loading and flow coefficients are prescribed inputs, but now with values determined under the goal of geometric correspondence between charge and generation turbo machinery.
System power capacity in charge mode is taken to be a free parameter, bringing total numerical degrees of freedom (DOFs) to five (four from Table 1 (φ,ϕ)_{comp}, (φ,ϕ_{turb}).

It is noted that eleven numerical inputs are needed for full definition of meanline blade and passage geometry, leaving the above problem specification underspecified. The approach taken was to obtain numerical solutions under various alternative choices for error parameters, identifying a winning candidate for which non-zero errors were best minimized. A multivariate (Newton-Raphson) algorithm was adopted.

The aerodynamic design solution is summarized in Table 1 and FIGS. 12 and 13 from which observations are drawn as follows:
Stage counts in generation mode were chosen as 13, 19 (compressor, turbine). For both generation and charge modes, values of stage specific speed are noted to fall in the high-efficiency range for compressors, and somewhat above for turbines.
Stage flow and loading coefficients, whose values in generation mode were specified to fall within high-efficiency ranges for compressor and turbine stages, are also found to be favorable in charge mode.
Generation power capacity was specified as 17 MW, this choice coupled to assignment of stage count and optimization of specific speed. Charge power capacity was calculated to be 29.6 MW, this figure giving agreement between charge and generation mass flow within 3%, making for nearly equal duration of charge and generation cycles.
Geometric alignment of charge and generation geometry was achieved within close tolerance, the maximum angle discrepancy found to be about 2.1 degrees. With the same hardware applied for generation and charge, this implies a maximum inlet incidence error comparable to those tabulated in FIG. 12.

FIG. 12 illustrates the gas flow velocity vectors relative to the blade metal angle for operation in compressor and turbine modes, with numerical results tabulated.

FIG. 13 is a cross-sectional drawing of the cold compressor/turbine, with details of the counter-rotating blade rows, and co-axial shaft and bearings.

TABLE 1
Summary of aerodynamic parameters during generation and charge. Relative Mach numbers are
above preference at compressor 1st stage inlets, and turbine last (Nth) stage exits.
Generation

| | Generation Compressor | | | | Generation Turbine | | | | | Compressor | Turbine |
|---|---|---|---|---|---|---|---|---|---|---|---|
| | Inlet Stg 1 | Exit Stg 1 | Inlet Stg N | Exit Stg N | Inlet Stg 1 | Exit Stg 1 | Inlet Stg N | Exit Stg N | N_{stages} | 13 | 19 |
| Mach [symbol] | 0.306 | 0.295 | 0.237 | 0.233 | 0.222 | 0.224 | 0.267 | 0.270 | [symbol] | 0.35 | 0.30 |
| Mach [symbol] | 0.798 | 0.580 | 0.617 | 0.453 | 0.406 | 0.518 | 0.488 | 0.625 | [symbol] | 0.45 | 0.53 |

| | | | | | | | | | | | |
|---|---|---|---|---|---|---|---|---|---|---|---|
| Mach [symbol] | 0.957 | 0.742 | 0.685 | 0.494 | 0.438 | 0.656 | 0.624 | 0.779 | power | 17000 | KW |

| | | | | | | | |
|---|---|---|---|---|---|---|---|
| NS [symbol] NS [symbol] | 3.17 | 1.83 | 1.87 | 3.41 | massflow | 119.6 | kg/s |

| | | | | | |
|---|---|---|---|---|---|
| NS [symbol] | 2.50 | 2.64 | p [symbol] | 100 | kPa |

| | | |
|---|---|---|
| N | 3600 | rpm |

Charge

| | Charge Compressor | | | | Charge Turbine | | | | | Compressor | Turbine |
|---|---|---|---|---|---|---|---|---|---|---|---|
| | Inlet Stg 1 | Exit Stg 1 | Inlet Stg N | Exit Stg N | Inlet Stg 1 | Exit Stg 1 | Inlet Stg N | Exit Stg N | N [symbol] | 19 | 13 |
| Mach [symbol] | 0.287 | 0.283 | 0.235 | 0.233 | 0.242 | 0.245 | 0.288 | 0.294 | [symbol] | 0.32 | 0.22 |
| Mach [symbol] | 0.646 | 0.494 | 0.524 | 0.407 | 0.526 | 0.640 | 0.627 | 0.757 | [symbol] | 0.55 | 0.44 |
| Mach [symbol] | 0.795 | 0.832 | 0.570 | 0.447 | 0.577 | 0.690 | 0.795 | 0.957 | power | 29581 | kW |

| | | | | | | | |
|---|---|---|---|---|---|---|---|
| NS [symbol] NS [symbol] | 3.91 | 2.37 | 2.31 | 3.80 | massflos | 123.1 | kg/s |

| | | | | | |
|---|---|---|---|---|---|
| NS [symbol] | 3.14 | 3.05 | p [symbol] | 100 | kPa |

| | | |
|---|---|---|
| N | 3800 | rpm |

[symbol]

indicates data missing or illegible when filed

Close geometric correspondence of generation and charge geometry is achieved, the most significant discrepancy an angle error of 2.1 degrees. This implies a flow-incidence error of roughly this value in transitioning between charge and generation modes. Aside from lowered aerodynamic losses, small incidence excursions will allow for the design of blade sections having narrow leading edges, minimizing trailing-edge blockage under reversed flow.

### Overview of Mechanical Innovations

The emergence of commercial magnetic bearings provides basis for the innovative embodiment of counter-rotating turbo machinery pictured in FIG. 10. Under this concept the outer shaft is fabricated from a non-magnetic material, permitting magnetic levitation of the inner shaft without direct physical access. Further attractions to the Brayton-Laughlin cycle stem from low maintenance requirements and exceptionally high mechanical efficiency characteristic of magnetic bearings.

The proposed mechanical layout uses a motor-generator situated at both ends of the rotor system. The 17 MWe commercial embodiment is designed to use standard 2-pole 3600 RPM motor/generators rotating in opposite directions. The bearing system is made dynamically stable through the use of 8 bearings as indicated on the drawing below. Bearings, B1, B2, B7 and B8 are integral with the electrical machine, these connected to turbo machinery by flexible couplings. Bearings B3 and B6 are magnetic bearings supporting ends of two drum rotors. B4 and B5 are the co-axial bearing illustrated in FIGS. 9 and 10. The capability of magnetic bearings to provide damping at switching frequencies well above 60 HZ allows for the positioning of multiple bearings on a rigid shaft, situated at bending nodes.

The drum rotor arrangement permits internal and external blade rows to rotate in opposite directions. Brayton has performed FEA stress analysis of the 17 MW progenitor, confirming rotor dynamic stability and structural feasibility. By virtue of the very low tip speeds (<180 m/s), the rigid drums operate comfortably within manageable stress and dynamic ranges.

FIGS. 7 and 8 show a mechanical arrangement for reversible, counter rotating turbo machine with motor-generators. Dimensions for 17 MWe. FIG. 10 provides a close-up of the inner magnetic bearing pair.

### Alternative Arrangements

Yet another embodiment of said reversing turbo machine provides dual functionality of said heat pump and gas turbine generator. As previously described said heat pump turbine and compressor alternately operate as said gas turbine generator by reversing the flow direction and direction of rotation. In an alternative to the aforementioned counter rotating blade rows, the single turbo machine comprises a compressor, turbine and electrical machine may be configured with all blade rows rotating in a common direction in said heat pump mode and operating in the opposite direction in said generation mode. In this configuration an articulating stator vane must be configured between alternating rotating blade rows. The position of said articulating or positionally adjustable stator vanes will change or flip over, when switching from heat pump to gas turbine generator.

Yet another alternative arrangement of the disclosure employs a radial or centrifugal compressor and a radial turbine. As in the aforementioned turbo machine, said first compressor, first turbine, and first electrical machine function as a heat pump convert to a second compressor, second turbine, and separate electrical machine operating as a gas turbine generator. In toggling between modes, the flow direction and direction or rotation change polarity. Further, said first turbine functions as said second compressor and said first compressor functions as said second turbine, and said first electrical machine functions as said second electrical machine.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An apparatus for transferring energy in an energy storage system, comprising:
a cold turbo machine having a plurality of blade rows, wherein an outer diameter of each blade row of the plurality of blade rows of the cold turbo machine descends in size between a first opening and a second opening of the cold turbo machine;
a hot turbo machine having a plurality of blade rows, wherein an outer diameter of each blade row of the plurality of blade rows of the hot turbo machine descends in size between a first opening and a second opening of the hot turbo machine, and wherein a common shaft operably joins the plurality of blade rows of the cold turbo machine and the plurality of blade rows of the hot turbo machine; and
a motor/generator operably engaged to the common shaft, wherein, in a first mode of operation, electricity is supplied to the motor/generator which drives the common shaft such that the cold turbo machine is a turbine and the hot turbo machine is a compressor, and wherein, in a second mode of operation, the cold turbo machine is a compressor and the hot turbo machine is a turbine to rotate the common shaft such that the motor/generator produces electricity.

2. The apparatus of claim 1, wherein the plurality of blade rows of the cold turbo machine have an odd number of blade rows, and the odd-numbered blade rows rotate in a first direction and the even-numbered blade rows rotate in an opposing, second direction during the first mode of operation, and the odd-numbered blade rows rotate in the second direction and the even-numbered blade rows rotate in the first direction during the second mode of operation; and
wherein the plurality of blade rows of the hot turbo machine have an odd number of blade rows, and the odd-numbered blade rows rotate in the first direction and the even-numbered blade rows rotate in the second direction during the first mode of operation, and the odd-numbered blade rows rotate in the second direction and the even-numbered blade rows rotate in the first direction during the second mode of operation.

3. The apparatus of claim 2, wherein the common shaft comprises an inner shaft connected to the odd-numbered blade rows of the plurality of blade rows of the cold turbo machine and connected to the odd-numbered blade rows of the plurality of blade rows of the hot turbo machine, and the common shaft comprises an outer shaft connected to the even-numbered blade rows of the plurality of blade rows of the cold turbo machine and connected to the even-numbered blade rows of the plurality of blade rows of the hot turbo machine.

4. The apparatus of claim 3, wherein the motor/generator is connected to the inner shaft, and a second motor/generator is connected to the outer shaft.

5. The apparatus of claim 4, wherein the motor/generator is connected to one end of the common shaft, and the second motor/generator is connected to an opposing end of the common shaft.

6. The apparatus of claim 3, further comprising at least one magnetic bearing between the inner shaft and the outer shaft such that the inner shaft and the outer shaft do not contact each other.

7. The apparatus of claim 6, wherein a first magnetic bearing is positioned proximate to a non-magnetic portion of the outer shaft and a magnetic portion of the inner shaft, and a second magnetic bearing is positioned proximate to a magnetic portion of the outer shaft.

8. An apparatus for transferring energy in an energy storage system, comprising:
a cold turbo machine having a plurality of blade rows, wherein a blade of at least one blade row of the plurality of blade rows of the cold turbo machine has a leading edge geometry that is substantially the same as a trailing edge geometry;
a hot turbo machine having a plurality of blade rows, wherein a blade of at least one blade row of the plurality of blade rows of the hot turbo machine has a leading edge geometry that is substantially the same as a trailing edge geometry, and wherein a common shaft operably joins the plurality of blade rows of the cold turbo machine and the plurality of blade rows of the hot turbo machine; and
a motor/generator operably engaged to the common shaft, wherein, in a first mode, electricity is supplied to the motor/generator which drives the common shaft such that the cold turbo machine operates as a turbine and the hot turbo machine operates as a compressor, and wherein, in a second mode, the cold turbo machine operates as a compressor and the hot turbo machine operates as a turbine to rotate the common shaft such that the motor/generator produces electricity.

9. The apparatus of claim 8, wherein velocity triangles characterizing a flow of working fluid at the leading edge and at the trailing edge of the blade of at least one blade row of the plurality of blade rows of the cold turbo machine are substantially symmetric between the first mode and the second mode; and
wherein velocity triangles characterizing a flow of working fluid at the leading edge and at the trailing edge of the blade of at least one blade row of the plurality of blade rows of the hot turbo machine are substantially symmetric between the first mode and the second mode.

10. The apparatus of claim 8, wherein an outer diameter of each blade row of the plurality of blade rows of the cold turbo machine descends in size between a first opening and a second opening of the cold turbo machine, and wherein an outer diameter of each blade row of the plurality of blade rows of the hot turbo machine descends in size between a first opening and a second opening of the hot turbo machine.

11. The apparatus of claim 10, wherein a cross-sectional area of the first opening of the hot turbo machine is greater than a cross-sectional area of the second opening of the hot turbo machine, greater than a cross-sectional area of the first opening of the cold turbo machine, and greater than a cross-sectional area of the second opening of the cold turbo machine.

12. The apparatus of claim 10, wherein the outer diameter of each blade of the plurality of blades of the hot turbo machine is greater than the outer diameter of each blade of the plurality of blades of the cold turbo machine.

13. The apparatus of claim 8, further comprising a first non-rotating blade row at one end of the plurality of blade rows of the cold turbo machine and a second non-rotating blade row at an opposing end of the plurality of blade rows of the cold turbo machine.

14. The apparatus of claim 8, wherein the common shaft is configured to rotate between 3300 and 3900 revolutions per minute in the first mode and between approximately 3300 and 3900 revolutions per minute in the second mode.

15. An energy transfer system, comprising:
a turbine and a compressor arranged on a common shaft, wherein a motor/generator is operably connected to the common shaft;
a hot reservoir having a higher temperature than a cold reservoir;
wherein, in a first mode of operation, a working fluid flows from the cold reservoir to an inlet of the compressor where the working fluid is compressed and exits through an outlet of the compressor at a higher temperature;
wherein the working fluid flows from the compressor to the hot reservoir where the working fluid further increases in temperature;
wherein the working fluid flows from the hot reservoir to an inlet of the turbine where the working fluid causes the turbine to rotate the common shaft, which causes the motor/generator to produce electricity;
wherein the working fluid exits through an outlet of the turbine at a lower temperature and returns to the cold reservoir; and
wherein, in a second mode of operation, electricity is supplied to the motor/generator to rotate the common shaft, the working fluid flows in the opposite direction, the turbine functions as a second compressor, and the compressor functions as a second turbine to transfer heat energy from the cold reservoir to the hot reservoir.

16. The energy transfer system of claim 15, further comprising a heat exchanger where the working fluid flowing out of the outlet of the turbine transfers heat to the working fluid flowing from the outlet of the compressor to the hot reservoir.

17. The energy transfer system of claim 15, wherein the compressor has a plurality of blade rows, wherein an outer diameter of each blade row of the plurality of blade rows of the compressor descends in size between the inlet and the outlet of the compressor along a first longitudinal direction along the common shaft; and
wherein the turbine has a plurality of blade rows, wherein an outer diameter of each blade row of the plurality of blade rows of the turbine descends in size between the outlet and the inlet of the turbine in an opposing, second longitudinal direction along the common shaft.

18. The energy transfer system of claim 17, wherein the plurality of blade rows of the compressor have an odd number of blade rows, and the odd-numbered blade rows rotate in a first rotational direction and the even-numbered blade rows rotate in an opposing, second rotational direction during the first mode of operation, and the odd-numbered blade rows rotate in the second rotational direction and the even-numbered blade rows rotate in the first rotational direction during the second mode of operation; and
wherein the plurality of blade rows of the turbine have an odd number of blade rows, and the odd-numbered blade rows rotate in the first rotational direction and the even-numbered blade rows rotate in the second rotational direction during the first mode of operation, and the odd-numbered blade rows rotate in the second rotational direction and the even-numbered blade rows rotate in the first rotational direction during the second mode of operation.

19. The apparatus of claim 18, wherein the common shaft comprises an inner shaft connected to the odd-numbered blade rows of the plurality of blade rows of the compressor and connected to the odd-numbered blade rows of the plurality of blade rows of the turbine, and the common shaft comprises an outer shaft connected to the even-numbered blade rows of the plurality of blade rows of the compressor and connected to the even-numbered blade rows of the plurality of blade rows of the turbine.

20. The apparatus of claim 19, wherein the motor/generator is connected to the inner shaft, and a second motor/generator is connected to the outer shaft, and wherein the motor/generator is connected to one end of the common shaft, and the second motor/generator is connected to an opposing, second end of the common shaft.
